(19) United States
(12) Patent Application Publication
(10) Pub. No.: US 2009/0247098 A1
(43) Pub. Date: Oct. 1, 2009

(54) System and Method for Autoranging in Test Apparatus

(76) Inventors: Thomas A. Gray, Santa Rose, CA (US); Robert Buck, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/057,290

(22) Filed: Mar. 27, 2008

(51) Int. Cl. H04B 1/16

(52) U.S. Cl. 455/161.1; 455/200.1

(57) ABSTRACT

A system for receiving signals and performing autoranging is disclosed. The system includes an adjustable attenuator at an input. A mixer combines the input signal with a tuning frequency to generate a mixed signal. The mixed signal is filtered to generate a component of the input signal at the tuning frequency. A signal detector detects the signal level of the input signal and the adjustable attenuator is adjusted in response to the signal level.

### CROSS-REFERENCE TO RELATED APPLICATIONS

This application claims priority to provisional patent application Ser. No. 60/722,251, titled “Autoranging in Test Apparatus,” by Thomas A. Gray and Robert Buck, filed Sep. 30, 2005, and incorporated herein by reference and from PCT application WO US06/026,498 filed Jun. 30, 2006.

### BACKGROUND OF THE INVENTION

Many kinds of test apparatus receive, at various times, input signals of differing strengths. Often the test apparatus must be designed to give accurate test outputs when working with such input signals, sometimes over a wide range of signal strengths. For example, a voltmeter might be required to measure accurately any voltage from 0.01 to 1,000 volts, a range of six orders of magnitude.

There are various ways to configure a test apparatus so that it can accommodate signals of differing strengths. One way to do this is to provide a manual attenuator for the user. There are several drawbacks to this approach, one of which is that manual setting of attenuation can be difficult when measuring off the air where parameters of the signal may be constantly changing. Another way is to provide some kind of automatic attenuation whereby the test apparatus adjusts its sensitivity to the magnitude of the signal being presented at an input port.

Some test instruments, spectrum analyzers for example, work with RF signals. In such instruments, components that can be overloaded or otherwise adversely affected by large signals are front end attenuator stages, RF switches, RF preamplifiers, and first mixers in RF tuners. IF stages can also be affected, but in instruments in which IF signals are measured by means of an analog-to-digital converter (ADC), detection of an overload condition is more evident. In some situations, signals that are outside the IF bandwidth can cause subtle to serious measurement errors without the knowledge of the user. It is therefore desirable to provide automatic attenuation to keep the signal in a range that can be accommodated by the instrument without any action by the user.

One kind of automatic attenuation is called autoranging. The goal of an autorange function in such an instrument is to attenuate any large RF signals sufficiently as to not cause compression in the “front end” (that is, in the input stages of the instrument). Theoretically, it would be possible to accomplish autoranging with an electromechanically switched attenuator, but in practice the switches wear out quickly. Therefore an electronic attenuation system would be preferable.

The dominant compression mechanism in the front end is usually the first mixer. It has been shown that the 1 dB compression point varies only slightly with frequency when referenced to the first IF signal level and varies by 10 to 15 dB referenced to the RF input due to frequency-dependent losses in the RF stages that precede the mixer.

One autorange solution uses broadband RF detectors in the RF front end section to detect signal level. The output of the detector controls an electronic attenuator. This arrangement has the disadvantage that an extra guard band must be built in to handle frequency-related losses in the front end and non-constant frequency response of the detector itself, as described previously. The result could be too much attenuation, which has the effect of degrading the dynamic range of the instrument.

Further limitations and disadvantages of conventional and traditional approaches will become apparent to one of skill in the art, through comparison of such systems with some aspects of the present invention as set forth in the remainder of the present application with reference to the drawings.

### SUMMARY

In view of the above, examples of systems consistent with the present invention for tuning a signal comprise an input for receiving an input signal. The system also includes an adjustable attenuator for attenuating the input signal. A mixer combines the input signal with a tuning frequency signal to generate a mixed signal. A band pass filter generates a filtered signal at an intermediate (“IF”) frequency. The system includes a signal detector for detecting an amplitude of the input signal and a controller for adjusting the adjustable attenuator in response to the amplitude of the input signal.

Various advantages, aspects and novel features of the present invention, as well as details of an illustrated embodiment thereof, will be more fully understood from the following description and drawings.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 depicts operation of a spectrum analyzer of the type that would make advantageous use of examples of the present invention.

FIG. 2 is a block diagram of a system using a receiver module that performs autoranging in a manner consistent with examples of the present invention.

FIG. 3 is a flowchart depicting an example of a method for autoranging consistent with the present invention.

FIGS. 4A and 4B are block diagrams of an example of a system for autoranging in a spectrum analyzer.

### DETAILED DESCRIPTION

In the following description of the preferred embodiment, reference is made to the accompanying drawings that form a part hereof, and which show, by way of illustration, a specific embodiment in which the invention may be practiced. Other embodiments may be utilized and structural changes may be made without departing from the scope of the present invention.

Examples of the present invention may find advantageous use in any apparatus, system or method that processes electrical signals, signals containing radio frequency (“RF”) signals in particular. The following description uses a spectrum analyzer as an example, but any apparatus or device that tunes signals may also be used. A spectrum analyzer is typically used to plot the frequency components of a signal on a display. General operation of spectrum analyzers is well known in the art. The typical display is a plot of amplitudes against a range of frequencies. Frequency components of the input signal, f_{SIG}, typically appear as spikes or signals at individual frequency values along an x-axis.

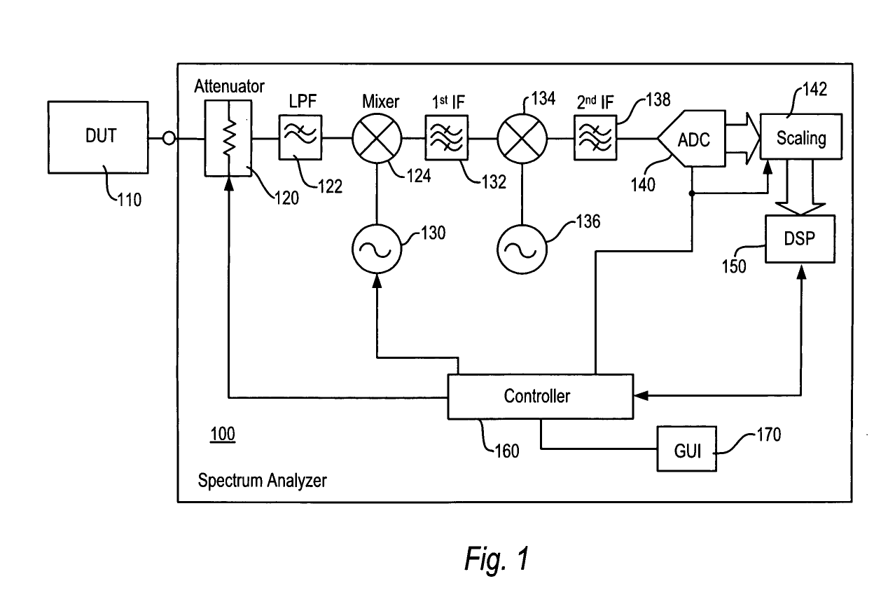

FIG. 1 is a block diagram depicting operation of a spectrum analyzer 100 being used to analyze a RF signal, f_{SIG}, being generated by a device-under-test (“DUT”) 110. The spectrum analyzer 100 includes an attenuator 120 and a low-pass filter 122 in the spectrum analyzer 100 front-end. The spectrum analyzer 100 receives the RF signal from the DUT 110 and couples the signal to a first mixer 124, which mixes the RF input signal with a local oscillator signal, f_{LO1}, generated by a first local oscillator 130. In the spectrum analyzer 100 in FIG. 1, the front end is the portion formed by components to the left of and including the first mixer 124.

The first mixer 124 generates a mixed signal formed by combining the input signal, f_{SIG}, and the local oscillator signal, f_{LO1} The mixed signal is coupled to a first intermediate frequency (“IF”) stage 132. The first IF stage 132 includes a band-pass filter having a center frequency indicated as an IF frequency, f_{IF}. The first IF stage 132 outputs a filtered signal to a second mixer 134. The second mixer 134 mixes the filtered signal with a second signal, f_{LO2}, generated by a second local oscillator 136 to produce a second mixed signal. The second mixed signal is filtered at a second IF stage 138 by a second band-pass filter having a center frequency, f_{IF2}. The output of the second IF stage 138 is a second filtered signal and as the local oscillator signal, f_{LO1}, sweeps through its entire tuning range, the second filtered signal represents the various frequency components of the input signal, f_{SIG}. These components are captured using an analog-to-digital converter (“ADC”) 140 and may be plotted against the tuning frequency on a display. The signal output from the ADC 140 is a digital value that is input to a scaling function 142 and then to a digital signal processor 150 for processing before it gets plotted as a signal scan on a graphical user interface (“GUI”) 170 by a controller 160.

The signal scan that appears on the display of the GUI 170 follows the range of frequencies used as the tuning frequency. The first local oscillator 130 generates the local oscillator signal, f_{LO1}, along a tuning frequency range in a manner dictated by a program executed by the controller 160. For example, the controller 160 may have the first local oscillator 130 generate the local oscillator signal, f_{LO1}, by starting at a first frequency and sweeping, or stepping, up or down to a second frequency over the tuning frequency range. The controller 160 may generate a sawtooth or ramping signal that drives the first local oscillator 130, which may be a voltage-controlled oscillator. The controller 160 may be a central processing unit (“CPU”) that provides functions described herein under program control in combination with supporting circuitry. In an alternative example, the controller may be replaced by a ramp generator, and/or suitable circuitry.

The spectrum analyzer 100 of FIG. 1 may be used to analyze signals having a frequency that lies within a given frequency range. The tuning frequencies generated by the first local oscillator 130 and the center frequency of the first and second IF stages 132, 138 are design parameters that are selected according to the frequency range to be measured by the spectrum analyzer 100. In a single stage analyzer, the f_{LO} and the f_{IF} are chosen such that the input signal frequency, f_{SIG}=f_{LO}−f_{IF}. The spectrum analyzer 100 in FIG. 1 is a two-stage analyzer meaning that it has two IF stages 132, 138 and the tuning frequency, f_{LO}, is the combination of the frequencies of the local oscillators 130, 136 such that:

f_{SIG}=f_{LO1}−(f_{LO2}−f_{IF2}) (1)

The spectrum analyzer 100 in FIG. 1 may implement an autoranging technique in which a signal detector (not shown) indicates to the CPU that the RF input signal, F_{SIG}, has reached an amplitude that may cause measurement errors. The spectrum analyzer 100 may implement an example of an autoranging technique that detects signal amplitude after the second IF stage 138. The spectrum analyzer 100 shown in FIG. 1 uses a two-stage receiver. However, one of ordinary skill in the art will appreciate that any number of IF stages may be used.

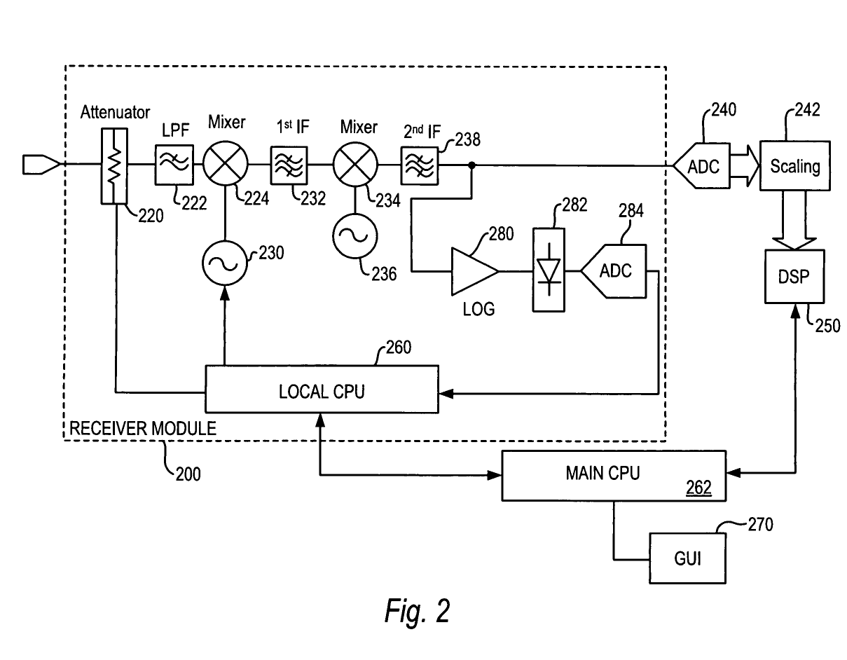

FIG. 2 is an example of a spectrum analyzer that uses a receiver module 200 for receiving a RF signal and performing auto-ranging in a manner consistent with the present invention. The receiver module 200 includes an adjustable attenuator 220 and a low pass filter 222 in the front end. The input signal is combined at a mixer 224 with a tuning frequency signal, f_{LO1}, generated by a first tuning oscillator 230. The mixed signal is input to a first IF stage 232, the output of which is combined at mixer 234 with a signal generated by a second tuning oscillator 236. The mixed signal is filtered at second IF stage 238 to generate the input signal components as the tuning frequency signal sweeps through the frequency range. The receiver module 200 in FIG. 2 uses a local CPU 260 to control the adjustable attenuator 220, control the sweep of the frequency range at the first tuning oscillator 230, and perform other control functions that may be needed.

At the second IF stage 238, however, the filtered signal is coupled to an amplifier 280 and detector 282, which make up a logarithmic detector in the example shown in FIG. 2. The detector outputs a signal that indicates the amplitude of the input signal at the input of the receiver module 200. The signal is converted to a digital signal by ADC 284. As a digital signal, the local CPU 260, through program control, determines whether the signal level at the receiver module 200 input should be attenuated and to what extent it should be attenuated. The local CPU 260 then adjusts the adjustable attenuator 220 in accordance with the autoranging function.

The filtered signal from the second IF stage 238 is also coupled to ADC 240 and may be plotted against the tuning frequency on a display. The signal output from ADC 240 is a digital value that is input to a scaling function 242 and then to a digital signal processor 250 for processing before it gets plotted as a signal scan on GUI 270 by the main CPU 262.

In one example of an embodiment, the local CPU 260 may adjust the adjustable attenuator 220 to achieve a predetermined constant signal level. For signals outside the analyzer's 1^{st} IF bandwidth, the first mixer is the dominant source of compression and its characteristics are known by the local CPU 260. If different measurement modes are desired to allow the user to select between optimizing single tone dynamic range, two tone dynamic range or just pure sensitivity at the expense of increased compression, then the main CPU 262 may communicate information relating to the different measurement modes to the local CPU 260. This may entail communicating information at a high level, e.g. “use sensitivity mode”, or the main CPU 262 may send a specific amplitude threshold to the local CPU 260, which it may then use to set the adjustable attenuator 220. The main CPU 262 may be used to provide other information relating to the adjustment of the attenuator 220. Even though the mixer and first IF amp may be protected from out of band signals, it does not necessarily mean that the rest of the signal path is protected from in band signals. Since these signals are measured by the measurement ADC, the main CPU 262 may evaluate whether or not the in band signal required more or less front end attenuation.

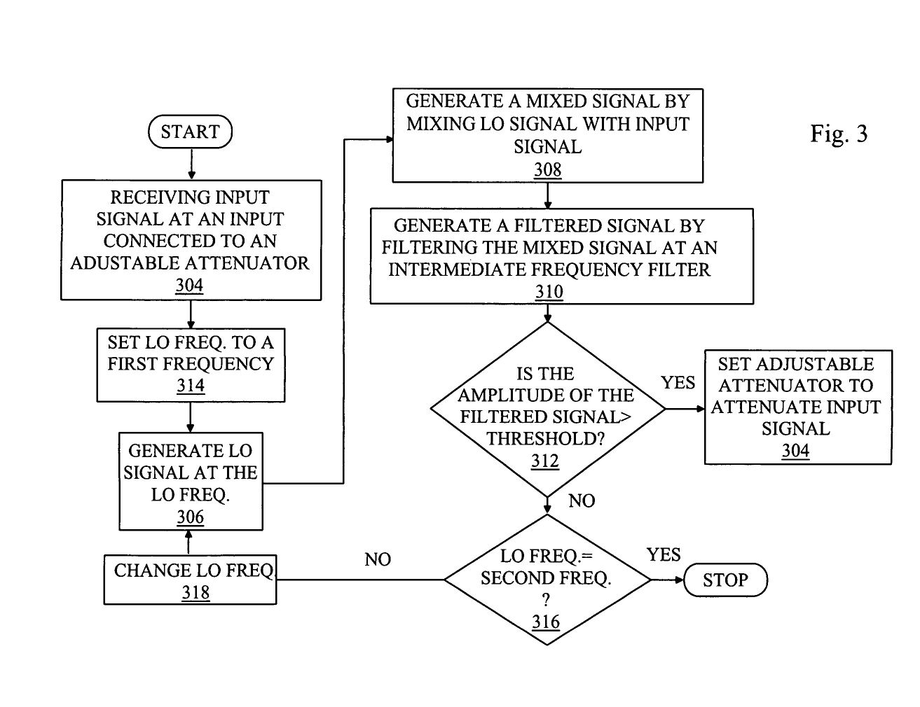

FIG. 3 is a flowchart depicting operation of an example of a method for performing autoranging consistent with the present invention. One of ordinary skill in the art would appreciate that the method shown in FIG. 3 may be implemented in any signal receiver in which a signal is tuned using a superheterodyne tuner. The signal receiver may be implemented in a test apparatus where the signal input may be difficult to control, or in any RF signal receiving system.

The method in FIG. 3 starts with receipt of an input signal connected to an adjustable attenuator at step 302. Concurrently, or as part of a setup process, a local oscillator is adjusted to generate a first local oscillator frequency signal as shown at step 304. At step 306, the local oscillator frequency signal is generated. A mixed signal is generated at step 308 by mixing the local oscillator frequency signal with the input signal, which is coupled to the mixer via the adjustable attenuator. At step 310, the mixed signal is filtered at an intermediate frequency filter to generate a filtered signal. At step 312, the filtered signal is analyzed to determine if its amplitude has reached a predetermined threshold indicative of an input signal that would cause gain compression in the front end. If the threshold has been met, the adjustable attenuator is set at step 314 to attenuate the input signal to bring it back within range. If not, processing proceeds to the normal function of the device. Since this may involve tuning through a frequency range to a second frequency, the next step may be one such as step 316, which checks to see if the second frequency has been reached. If it has, processing stops for this method. If not, the local frequency signal output from the local oscillator is adjusted to generate a next frequency at step 318. The local oscillator signal is output by the local oscillator at step 306.

One of ordinary skill in the art will appreciate that the change of the local oscillator frequency at step 316 may proceed as a sweep through the range, or as a process of stepping through the frequency range. One of ordinary skill in the art will also appreciate that the method shown in FIG. 3 has been simplified to work in a single stage tuner. A method consistent with the present invention may be implemented in a manner similar to that illustrated in FIG. 3 in a receiver having any number, N, of IF stages.

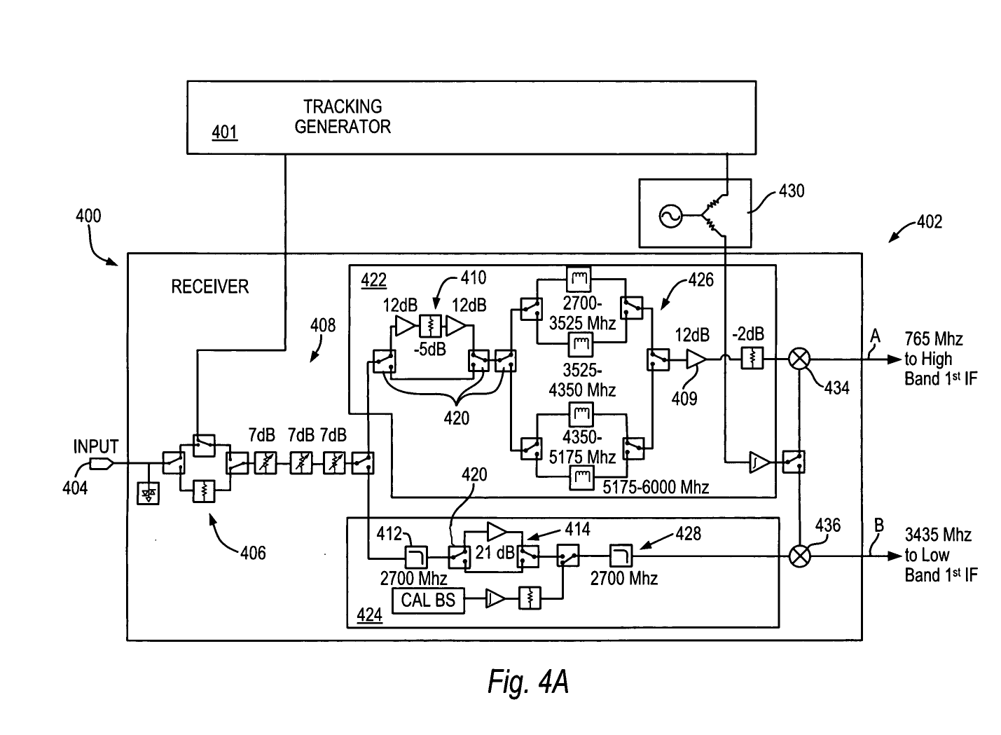

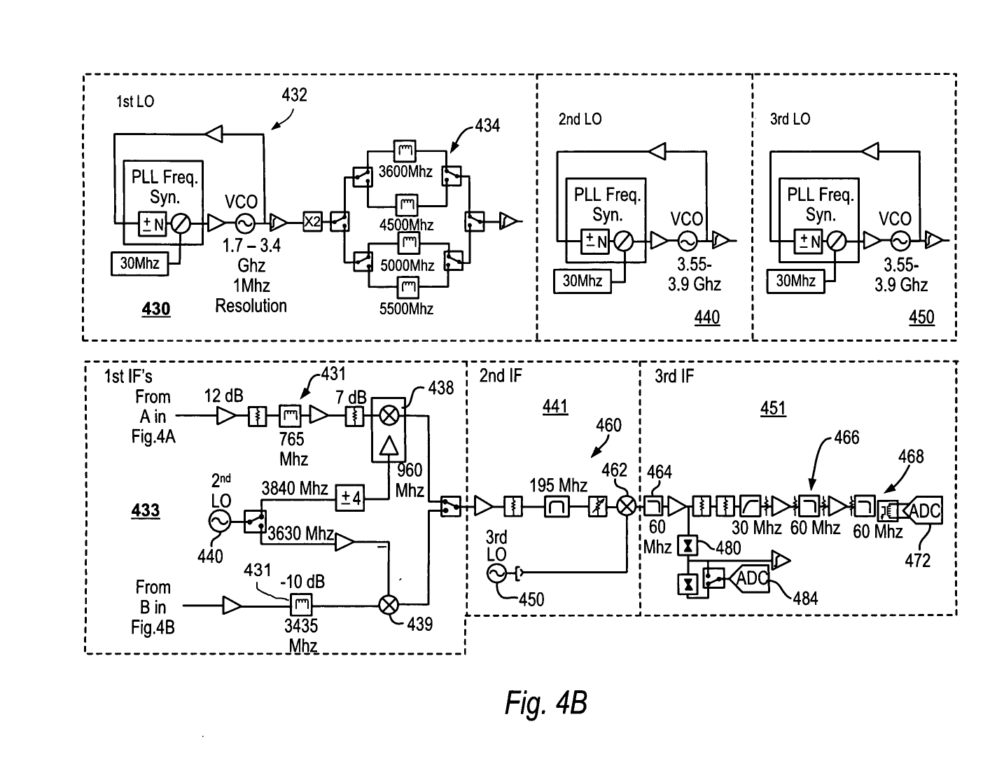

FIGS. 4A and 4B are schematics of an example of a spectrum analyzer 400 consistent with the present invention in more detail. FIG. 4A depicts a tracking generator 401 and a front end 402 of the analyzer 400. The analyzer 400 has a bandwidth of 100 kHz-6 GHz. The analyzer 400 and the tracking generator 401 may be used together for a variety of purposes such as characterizing components by determining, for example, the components' impedance.

The analyzer 400 in FIGS. 4A and 4B is a multi-band and multi-stage spectrum analyzer. The analyzer 400 includes the front end 402 followed by three IF stages. In the front end, 402, the input signal is processed in either a high-band mode by a high-band filter section 422, or in a low-band mode by a low-band filter section 424. In the high-band mode, the high-band filter section 422 mixes the input signal with a first local oscillator signal, generated by a first local oscillator 430 in the range from between about 3.4 GHz and about 6.8 GHz and couples the mixed signal to a first IF filter stage 433. The first IF filter stage 433 filters the mixed signal in the high-band mode at 765 MHz. In the low-band mode, the low-band filter section 422 mixes the input signal with the first local oscillator signal (which is in the same 3.4 to 6.8 GHz range) and couples the mixed signal to the first IF filter stage 433, but in the low band mode, the first IF filter stage 433 filters the mixed signal at 3435 MHz.

The filtered signal from either the low-band or high-band band-pass filter is then mixed with a second local oscillator signal generated by a second local oscillator 440. The filtered signal in the high-band mode is mixed at mixer 438 with a second local oscillator signal, generated by the second local oscillator 440 at about 3840 MHz and then divided by 4 before it is mixed with the filtered signal. The second local oscillator 440 may be configured to generate the second local oscillator signal at a frequency of about 3630 MHz, which is mixed at mixer 439 with the input signal in the low-band mode. The second mixed signal (in either the high-band mode or the low-band mode) is then coupled to a second IF stage 441 where it is filtered by a second stage band-pass filter 460 around a frequency of 195 MHz to generate a second filtered signal. The second filtered signal is mixed with a third local oscillator signal generated by a third local oscillator 450 at a second stage mixer 462 to generate a third mixed signal. The third mixed signal is coupled to a third IF stage 451, where it is filtered at a low-pass filter 464 with a cutoff frequency of 60 MHz. The tuning equation for the analyzer 400 in FIGS. 4A and 4B are as follows:

100 KHz-2700 MHz:

−RF+LO1−LO2+LO3=45 MHz=3^{rd} IF

−RF+LO1−3630 MHz+240 MHz=45 MHz

−RF+LO1=3435 MHz=1^{st} IF

2700 MHz-6000 MHz:

−RF+LO1−LO2+LO3=45 MHz=3^{rd} IF

−RF+LO1−960 MHz+240 MHz=45 MHz

−RF+LO1=765 MHz=1^{st}IF

In the third IF stage 451, the signal at the output of the low-pass filter 464 is coupled to digital interface section 466 and a signal detector 480. In the digital interface section 466, the signal is processed by a series of filters 468. The signal is converted to a digital signal representation of the analog signal for further analysis and processing by the processor. The signal detector 480 measures the level of the input signal. The analog level of the input signal is converted to a digital signal level by a second ADC 484. The processor checks the level against a threshold indicative of a signal level that would cause compression in the front end.

The front-end 402 of the analyzer in FIG. 4A includes the RF input 404, the attenuator 406, a high-band filter section 422, and a low-band filter section 424. The high-band front-end filter section 422 includes a band pass filter section 426 and a low-pass filter section 428. The front end 402 also includes attenuators, amplifiers 409 and attenuator/amplifier combinations 410 to condition the signal in a manner that may be controlled by the processor. The attenuators, amplifiers and filters in front of the 1^{st} mixer cause a large variation in the mixer level as a function of frequency and attenuator setting. The autoranging systems and methods consistent with the present invention measures the IF signal level and adjusts the attenuator to position the signal at the optimum level in the first mixer. The processor may control the operation of the analyzer 400 by controlling the state of switches 420 connected to effect functions according to programs controlling the processor. The processor may, for example, control certain switches 420 to enable use of the high-band filter section 422 instead of the low-band filter section 424. Other examples of functions that may be implemented by the processor control of the switches 420 include test functions. One such function may include inputting a signal from the tracking generator 401 into the analyzer 400 to test operation of the analyzer 400 given a known input signal.

The filter section employed at any given time is determined by the mode selected by a user of the analyzer 400. The mode may be implemented and switched with switches 420 controlled by the processor. In the high-band mode, the signal proceeds through an attenuator section 408 and is coupled to the high-band front-end filter section 422. The high-band front end filter section 422 in FIG. 4A includes four parallel-connected band-pass filters 426. The processor may select a signal path through one of the four band-pass filters 426 using the switches 420. The four band-pass filters 426 shown in FIG. 4A filter the signal through a range of between 2700 MHz and 6000 MHz. In the low-band mode, the signal proceeds through low-pass filters 428 with a cutoff of about 2700 MHz.

The front-end 402 includes components up to and including a first front-end mixer 434 and second front-end mixer 436. The first front-end mixer 434 mixes the RF input signal received from the high-band pass filter section 422 with a local oscillator signal generated by a first local oscillator 430 when the analyzer is in a high-band mode. The second mixer 431 mixes the RF input signal received from the low pass filter section 428 with the local oscillator signal when the analyzer is in a low-band mode.

The first local oscillator 430 details are shown in FIG. 4B. The first local oscillator 430 generates a signal having frequencies between about 3.4 and about 6.8 GHz. The first local oscillator 430 includes a phase-locked loop frequency synthesizer 432 controlled by the processor to generate frequencies between 1.7 and 3.4 GHz at 1 MHz increments. The output of the frequency synthesizer 432 is multiplied by 2 and coupled to a set of band pass filters 434. The first local oscillator signal is output to either the first or second front-end mixer, 434 or 436, to be mixed with the RF input signal.

The output of the first or second front end mixers, 434 or 436, is coupled to a first IF section 431. The first front end mixer 434 is connected to a high-band first IF section 433, which includes a band-pass filter centered at 765 MHz. In the high-band mode, the signal is filtered at the 765 MHz band-pass filter and mixed at the first IF section mixer 438 with a second IF signal generated by a second local oscillator 440.

The mixed signal output from either first front-end mixer 434 or second front-end mixer 436 is coupled to either a first section high-band IF filter or a first section low-band IF filter, depending on the analyzer mode. The mixed signal is filtered and the filtered signal is coupled to either a first section first mixer in the high-band mode or a first section second mixer in the low-band mode. The filtered signal is mixed with a second local oscillator signal generated by a second local oscillator. The second local oscillator 440 details are shown in the top center section of FIG. 4B. The output of the first section mixer 438 or 439 is coupled to a second section IF filter 460. The signal is filtered and mixed with a third local oscillator signal generated by a third local oscillator 450 at a second section mixer 462. The details of the third local oscillator 450 are shown in the top right section of FIG. 4B. The mixed signal output by the second section mixer 462 is filtered in a third section IF filter 466. The signal output from the third IF section filter 466 is coupled to the log detector 468. The signal output by the log detector 468 is converted to a digital signal by the ADC 472 and the digital signal is processed by the microcontroller to determine if the signal level has reached the threshold for adjusting the attenuator.

In the analyzer in FIGS. 4A and 4B, the front end compression level is near constant referenced to the IF signal level, with the result that accurate ranging can be done without giving up excess dynamic range. Detection of an out-of-band signal may be accomplished by tuning the first local oscillator. In some examples of the present invention, tuning and IF detection can advantageously be performed with the same mechanisms that are already built into the instrument for measurement purposes.

In some embodiments, a single printed circuit board assembly includes local oscillators 430, 440 and 450, an RF tuner 410, first and second IF stages 433 and 441, the detector 468, and an ADC 472. All these devices are controlled by a standalone microcontroller (not shown). The microcontroller can perform very fast multi-band tuning sweeps while sampling the IF detector. It is also possible to detect multiple large signals and increase input attenuation as appropriate. The IF detector 400 also has sufficient dynamic range that small signals can be detected and the RF tuner 410 can be controlled for even better system sensitivity. Since the autorange sweeps can occur autonomously, the processing can be overlapped with other work being performed by a main processor (not shown) elsewhere in the instrument, for example computing fast Fourier transforms (“FFTs”) thereby minimizing any impact on instrument throughput.

The signal level as detected by the detector 468 may also be used to adjust digital gain in a digital down converter (DDC) (not shown). The DDC converts the output of the third IF stage 451 as provided by an ADC 472 into a complex I-Q waveform. Too much digital gain causes numerical overloads. Too little gain causes quantization noise. Setting the gain properly for the input signal is essential to achieve the best sensitivity without overloading the DDCs numerical processing. Since only signals within the analog bandwidth of the IF amplifiers are of concern, the IF signal level is only sampled when the LO is tuned to the measurement frequency.

Alternatively, the DDC gain can be adjusted by looking at the output of the main measurement ADC. This would require a full rate I/Q conversion and detection of the ADC data. The resulting amplitude can then be used to set the DDC gain.

Although the above description refers to the configuration of parties engaged in wireless communication, the present invention is not limited to the particular aspects described. Variations of the examples provided above can be applied to a variety of network arrangements and technologies without departing from the spirit and scope of the present invention.

Persons skilled in the art will understand and appreciate, that one or more processes, sub-processes, or process steps described may be performed by hardware or software, or both. Additionally, the invention may be implemented completely in software that would be executed within a microprocessor, general-purpose processor, combination of processors, DSP, or ASIC. The invention may be realized in a centralized fashion in at least one computer system, or in a distributed fashion where different elements are spread across several interconnected computer systems. If the process is performed by software, the software may reside in software memory in the controller. The software in software memory may include an ordered listing of executable instructions for implementing logical functions (i.e., “logic” that may be implemented either in digital form such as digital circuitry or source code or in analog form such as analog circuitry or an analog source such an analog electrical, sound or video signal), and may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium”, “computer-readable medium” or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

While the present invention has been described with reference to certain embodiments, it will be understood by those skilled in the art that various changes can be made and equivalents can be substituted without departing from the scope of the present invention. It will be understood that the foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

Various modifications to the present invention will become apparent to those skilled in the art from the foregoing description and accompanying drawings. Accordingly, the present invention is to be limited solely by the scope of the following claims.

1. A method for autoranging in a radio-frequency (“RF”) receiver: comprising:
receiving an input signal at an adjustable attenuator;
mixing the input signal with a local oscillator signal to produce a mixed signal;
filtering the mixed signal at an intermediate frequency (“IF”) band pass filter;
testing an amplitude of the filtered signal; and
adjusting the attenuator to attenuate the input signal when the amplitude of the filtered signal indicates that the input signal amplitude is above a threshold.

2. The method of claim 1 where the step of mixing further comprises:
generating the local oscillator signal by setting a local oscillator to output the local oscillator signal at a first frequency and sweeping through a range to a second frequency.

3. The method of claim 1 where the step of mixing further comprises:
generating the local oscillator signal by setting a local oscillator to output the local oscillator signal at a first frequency and stepping through a range to a second frequency.

4. The method of claim 1 further comprising:
before the step of testing, mixing the filtered signal with a second signal; and
filtering the second mixed signal at a second IF band pass filter.

5. The method of claim 1 further comprising:
before the step of testing, mixing the filtered signal with multiple signals at a number ‘n’ mixers;
after each mixer, filtering the multiple mixed signal at n IF band pass filters.

6. The method of claim 1 where the step of testing the amplitude includes measuring an amplitude, the method further comprising:
using the amplitude to adjust a gain setting for a digital down converter.

7. A system for tuning a signal comprising:
an input for receiving an input signal;
an adjustable attenuator for attenuating the input signal;
a mixer for combining the input signal with a local oscillator signal to generate a mixed signal;
a signal detector for detecting an amplitude of the input signal; and
a controller for adjusting the adjustable attenuator in response to the amplitude of the input signal.

8. The system of claim 7 where the controller is a processor programmed to perform an autoranging function.

9. The system of claim 8 further comprising:
an analog-to-digital converter (“ADC”) connected to the signal detector for receiving the amplitude of the input signal and converting the amplitude to a digital value.

10. The system of claim 8 further comprising:
a digital down converter connected to the system to receive the amplitude and to adjust the ADC to prevent quantization errors and oversampling.

11. The system of claim 7 where the signal detector is a logarithmic detector.

12. The system of claim 7 further comprising a low pass filter after the adjustable attenuator to filter signals having frequencies higher than a number smaller than the IF frequency.

13. The system of claim 7 further comprising a sweeping frequency generator for generating the local oscillator signal by sweeping through a frequency range from a first frequency to a second frequency.

14. The system of claim 7 further comprising a stepping frequency generator for generating the local oscillator signal by stepping through a frequency range from a first frequency to a second frequency.

15. An RF signal receiver comprising:
an RF input for receiving an input signal;
an adjustable attenuator for attenuating the input signal;
a mixer for combining the input signal with a tuning frequency signal to generate a mixed signal;
a bandpass filter for generating a filtered signal at an intermediate (“IF”) frequency;
a signal detector for detecting an amplitude of the input signal; and
a controller for adjusting the adjustable attenuator in response to the amplitude of the input signal.

16. The RF signal receiver of claim 15 where the controller is a processor for performing an autoranging function.

17. The RF signal receiver of claim 16 further comprising:
an analog-to-digital converter (“ADC”) connected to the signal detector for receiving the amplitude of the input signal and converting the amplitude to a digital value.

18. The RF signal receiver of claim 16 further comprising:
an ADC connected to the last IF signal and a digital down converter connected to the ADC to receive the amplitude and to scale the ADC output to prevent quantization errors and overload.

19. The RF signal receiver of claim 15 where the signal detector is a logarithmic detector.

20. The RF signal receiver of claim 15 further comprising a low pass filter after the adjustable attenuator to filter signals having frequencies higher than a number smaller than the IF frequency.

21. The RF signal receiver of claim 15 further comprising a sweeping frequency generator for generating the local oscillator signal by sweeping through a frequency range from a first frequency to a second frequency.

22. The RF signal receiver of claim 15 further comprising a stepping frequency generator for generating the local oscillator signal by stepping through a frequency range from a first frequency to a second frequency.

23. An apparatus comprising
an RF receiver comprising:
an RF input for receiving an input signal;
an adjustable attenuator for attenuating the input signal;
a mixer for combining the input signal with a tuning frequency signal to generate a mixed signal;
a bandpass filter for generating a filtered signal at an intermediate (“IF”) frequency;
a signal detector for detecting an amplitude of the input signal; and
a controller for adjusting the adjustable attenuator in response to the amplitude of the input signal, and
an analog-to-digital converter that digitizes said filtered signal.
